(19) United States
(12) Patent Application Publication
(10) Pub. No.: US 2022/0163093 A1
(43) Pub. Date: May 26, 2022

(54) CENTRIFUGAL PENDULUM DEVICE HAVING AN END STOP

(71) Applicant: Schaeffler Technologies AG & Co. KG, Herzogenaurach (DE)

(72) Inventor: Uli Junker, Offenburg (DE)

(73) Assignee: Schaeffler Technologies AG & Co. KG, Herzogenaurach (DE)

(21) Appl. No.: 17/425,897

(22) PCT Filed: Jan. 9, 2020
(86) PCT No.: PCT/DE2020/100009

§ 371 Date: Jul. 26, 2021

(30) Foreign Application Priority Data
Jan. 28, 2019 (DE) 10 2019 101 960.5

(51) Int. Cl. F16F 15/14

(52) U.S. Cl. CPC F16F 15/145; F16F 2232/02; F16F 2230/007; F16F 2236/08; F16F 2226/044; F16F 2222/08

(57) ABSTRACT

A centrifugal pendulum device is arranged in the drive train of a motor vehicle, including at least one centrifugal pendulum which is arranged on a carrier disc and can perform a relative movement in relation to the carrier disc along a predetermined pendulum path. At least one radial stop surface is arranged on the carrier disc and the centrifugal pendulum has at least one stop means.

### CROSS-REFERENCE TO RELATED APPLICATIONS

This application is the U.S. National Phase of PCT Appln. No. PCT/DE2020/100009 filed Jan. 9, 2020, which claims priority to DE 102019101960.5 filed Jan. 28, 2019, the entire disclosures of which are incorporated by reference herein.

### TECHNICAL FIELD

The disclosure relates to a centrifugal pendulum device to be arranged in the drive train of a motor vehicle, having at least one centrifugal pendulum which is arranged on a carrier disc and can execute a movement relative to the carrier disc along a predetermined pendulum path.

### BACKGROUND

Generic centrifugal pendulum devices (CPD) are known, for example, from DE 10 2006 028 536 A1 having pendulum masses on both sides of a central pendulum flange, or from DE 102010 054 556 A1 as a double flange with pendulum masses between two pendulum flanges. Such centrifugal pendulum devices are now an important component for vibration isolation in the drive train of vehicles with internal combustion engines. Centrifugal pendulums are arranged, for example, on torsion dampers (e.g., dual-mass flywheels, DMF) or are part of a single-mass flywheel and can also be arranged on clutch covers, clutch discs, and the like.

In order to prevent the pendulum rollers from striking the ends of the kidney-shaped elongated holes in which they are received, it is known to arrange stop elements on the pendulum masses or the pendulum flange. These are equipped, for example, with rubber elements that are arranged on bolts. The damping elements come into action at low speed or at excessive excitations, which lead to a permissible oscillation angle of the centrifugal pendulum in relation to a rest position being exceeded.

### SUMMARY

An object of the disclosure is to provide a simple and inexpensive alternative for reducing impact noises of the pendulum masses.

This problem is resolved by a centrifugal pendulum device described herein. Preferred embodiments, designs, or further developments of the disclosure are also described herein.

The above-mentioned problem is solved in particular by a centrifugal pendulum device to be arranged in the drive train of a motor vehicle, having at least one centrifugal pendulum which is arranged on a carrier disc and can perform a movement relative to the carrier disc along a predetermined pendulum path, wherein at least one radial stop surface is arranged on the carrier disc and the centrifugal pendulum has at least one stop means. When a determined pendulum swing is exceeded, the stop means strikes the stop surface and prevents further pendulum movement so that neither a pendulum mass nor a pendulum roller strike the pendulum flange in a metallic manner.

In one embodiment of the disclosure, the stop means is arranged on a radial inner side of the centrifugal pendulum, and in a further embodiment of the disclosure is part of a spacer. The spacer is preferably a plastic component and prevents the pendulum mass from running up against the pendulum flange.

In one embodiment of the disclosure, the centrifugal pendulum comprises two pendulum masses which are arranged on both sides of the carrier disc, wherein the spacer is arranged on the side of one of the pendulum masses facing the carrier disc.

In one embodiment of the disclosure, the spacer is connected to the pendulum mass by means of a clip connection. For this purpose, a pin of the spacer protrudes into a hole and forms a press fit.

In one embodiment of the disclosure, the centrifugal pendulum comprises an additional mass arranged between the pendulum masses, wherein the spacer is arranged between the additional mass and the pendulum mass. The additional mass can consist of one sheet or multiple stacked sheets.

In one embodiment of the disclosure, the spacer is L-shaped and has an axially extending stop lug. A rubber element is preferably arranged, for example vulcanized, on the stop lug.

In one embodiment of the disclosure, the stop lug engages around the pendulum mass on its radial inner side. As a result, the stop lug is supported on the pendulum mass as soon as it hits the stop surface with the rubber element, so that the stop lug is prevented from breaking off.

In one embodiment of the disclosure, a rubber coating is arranged on the stop lug.

In one embodiment of the disclosure, at least one spacer is arranged on both pendulum masses. At least one spacer having one stop means is preferably provided for both pendulum directions.

### BRIEF DESCRIPTION OF THE DRAWINGS

Exemplary embodiments of the disclosure are explained in more detail below with reference to the accompanying drawings. In the figures:

FIG. 1 shows a centrifugal pendulum device according to the prior art as a comparative example,

FIG. 2 shows a first exemplary embodiment of a centrifugal pendulum device according to the disclosure as a schematic diagram in a sectional view,

FIG. 3 shows a second exemplary embodiment of a centrifugal pendulum device according to the disclosure as a schematic diagram in a sectional view,

FIG. 4 shows a third exemplary embodiment of a centrifugal pendulum device according to the disclosure as a schematic diagram in a sectional view.

### DETAILED DESCRIPTION

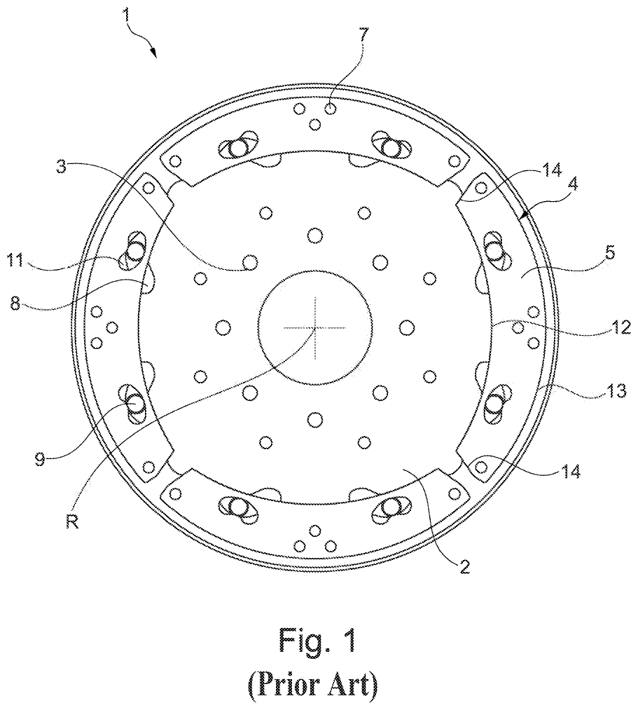

FIG. 1 shows an embodiment of a centrifugal pendulum device 1 in a plan view as a comparative example for understanding the disclosure. The centrifugal pendulum device 1 is substantially rotationally symmetrical with respect to an axis of rotation R. Here, the circumferential direction is understood to be a rotation about the axis of rotation R, the axial direction is understood to be the direction parallel to the axis of rotation R, and the radial direction is understood to be any direction perpendicular to the axis of rotation R. The centrifugal pendulum device 1 is arranged in the drive train of a motor vehicle between an internal combustion engine having a crankshaft and a disengageable vehicle clutch which is coupled to a transmission. The centrifugal pendulum device 1 comprises a carrier disc 2 which, in the installed position, is connected to a secondary flange, not shown, of a dual mass flywheel in the drive train of a motor vehicle, for example. The connection is made by a screw connection, for which a large number of bores 3 for receiving screws are arranged distributed over the circumference of the centrifugal pendulum device 1.

Multiple, in the present exemplary embodiment four, centrifugal pendulums 4 are distributed over the circumference of the centrifugal pendulum device 1. The centrifugal pendulums 4 each comprise a first or motor-side pendulum mass 5 and a second or transmission-side pendulum mass 6. The terms motor-side and transmission-side are used here solely to make it easier to distinguish and understand the device and the arrangement of the parts of the device. The first pendulum mass 5 and the second pendulum mass 6 are arranged on both sides of the carrier disc 2 and are firmly connected to one another. The first pendulum mass 5 and the second pendulum mass 6 are firmly connected to one another by multiple, in the present exemplary embodiment three, rivet bolts 7.

Both the first pendulum mass 5 and the second pendulum mass 6 have multiple holes drilled into them to accommodate the rivet bolts 7.

Pendulum rollers 9 are received in elongated holes 8 of the carrier disc 2. The pendulum rollers 9 each comprise a cylindrical central part which is provided with roller centering rims at both axial ends. The roller centering rims serve to fix the spherical rollers 9 in an axially form-fitting manner in the elongated holes 8. The roller ends of the pendulum rollers 9 that project axially beyond the respective roller centering rims each protrude into elongated holes 11 in the pendulum masses 5 and 6. The elongated holes 11, together with the elongated holes 8 and the pendulum rollers 9, enable a pendulum movement of the centrifugal pendulum 4 relative to the carrier disc 2. For this purpose, the roller paths for the pendulum rollers 9 are kidney-shaped and, together with the pendulum rollers 9 and the elongated holes 8, form a link guide for the centrifugal pendulum 4. The pendulum masses 5, 6 each have a radial inner side 12, a radial outer side 13 and two end faces 14.

The raceways of the pendulum rollers 9 with respect to the centrifugal pendulum flange 2 or the centrifugal pendulums 4 are designed in such a way that the centrifugal pendulums 4 can perform a pendulum movement of a so-called parallel pendulum (also known as 1^{st} generation), or a so-called trapezoidal pendulum (2^{nd} generation). At a maximum pendulum angle of the centrifugal pendulum 4 relative to the pendulum flange 2, the pendulum rollers 9 hit the ends of the elongated holes 8 and 11.

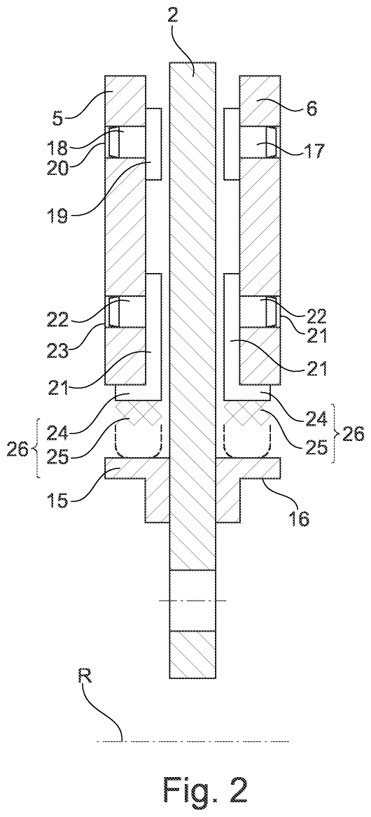

FIG. 2 shows an exemplary embodiment of a centrifugal pendulum device 1 according to the disclosure in a sectional view. Parts that are not essential for understanding the disclosure are not shown. As in the comparative example in FIG. 1, two pendulum masses 5, 6 that are firmly connected to one another are arranged on both sides of a pendulum flange and are mounted in a pendulum-like manner by means of pendulum rollers, not shown here.

On the radially inner side of the pendulum masses 5, 6 each of the radial stop surfaces 15, 16 are arranged on the pendulum flange. The stop surfaces 15, 16 have an L-shaped cross-section and are riveted, screwed or, in particular, welded to the pendulum flange. Alternatively, these can be worked out from the material of the pendulum flange 2, for example by punching or the like.

On the pendulum masses 5, 6 outer spacers 17 are arranged radially on the outer side. These are plastic clips which have a bolt part 18 and a head part 19. Each bolt part 18 is received by a bore 20 of one of the pendulum masses 5, 6. The head part 20 is spaced apart from the surface of the pendulum flange 2 and serves as a lubricant when the pendulum mass 5, 6 touches the pendulum flange 2. Inner spacers 21 are arranged radially on the inner side, which inner spacers likewise have a bolt part 22 which is received in a bore 23. The inner spacers 21 are extended radially inward and encompass the respective pendulum mass 5, 6 with a stop lug 24 on the radial inner side thereof. The stop lug 24 is provided with a rubber coating 25. The stop lug 24 and rubber coating 25 form a stop means 26 which strikes against the assigned stop surface 25, 16 when the pendulum mass 4 has a determined pendulum deflection. The determined pendulum swing is smaller than the maximum pendulum angle at which the pendulum rollers hit the ends of the elongated holes.

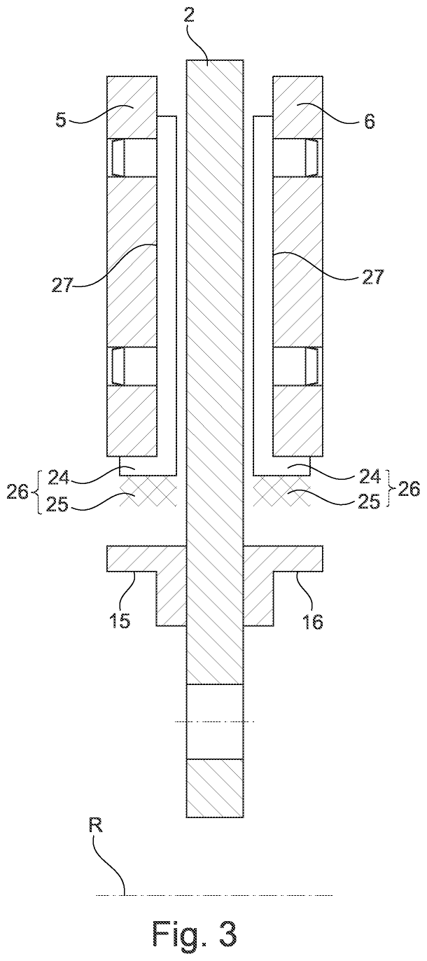

FIG. 3 shows an alternative embodiment in which the outer and inner spacers are combined to form a spacer 27. On the radial inside, the spacers 27 have the stop lug 24 and the rubber coating 25, which form the stop means 26.

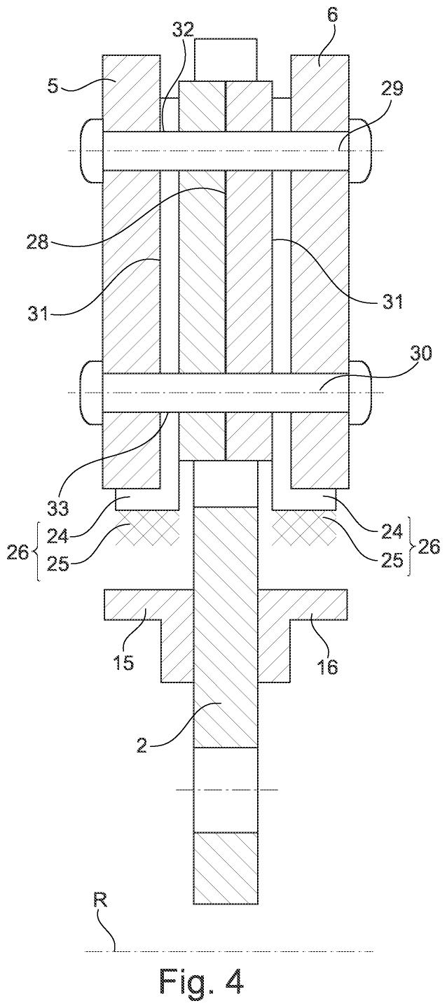

FIG. 4 shows a further exemplary embodiment for centrifugal pendulums 4 in which an additional mass 28 consisting of multiple sheet metal layers is arranged between the pendulum masses 5, 6. The pendulum masses 5, 6 and the additional mass 28 are firmly connected to one another with rivets 29, 30. L-shaped spacers 31 are arranged between the additional mass 28 and the respective pendulum mass 5, 6, wherein the rivets 29, 30 protrude through bores 32, 33 in the spacer 31. On the radial inside, the spacers 31 have the stop lug 24 and the rubber coating 25, which form the stop means 26.

### LIST OF REFERENCE NUMBERS

1 Centrifugal pendulum device

2 Carrier disc

3 Bore

4 Centrifugal pendulum

5 Motor-side pendulum mass

6 Transmission-side pendulum mass

7 Rivet bolt

8 Elongated hole

9 Pendulum roller

11 Elongated hole in pendulum mass

12 Radial inner side of the pendulum mass

13 Radial outer side of the pendulum mass

14 End face of the pendulum mass

15 Radial stop surface

16 Radial stop surface

17 Outer spacer

18 Bolt part

19 Head part

20 Bore

21 Inner spacer

22 Bolt part

23 Bore

24 Stop lug

25 Rubber coating

26 Stop means

27 Spacer

28 Additional mass

29 Rivet

30 Rivet

31 Spacer

32 Bore

33 Bore

1. A centrifugal pendulum is arranged in a drive train of a motor vehicle, the centrifugal pendulum device comprising:
at least one centrifugal pendulum arranged on a carrier disc and is configured to perform a movement relative to the carrier disc along a predetermined pendulum path, wherein at least one radial stop surface is arranged on the carrier disc and the centrifugal pendulum has at least one stop means.

2. The centrifugal pendulum device according to claim 1, wherein the stop means is arranged on a radial inner side of the centrifugal pendulum.

3. The centrifugal pendulum device according to claim 2, wherein the stop means is part of a spacer.

4. The centrifugal pendulum device according to claim 3, wherein the centrifugal pendulum comprises two pendulum masses arranged on both sides of the carrier disc and the spacer is arranged on a side of one of the pendulum masses facing the carrier disc.

5. The centrifugal pendulum device according to claim 4, wherein the spacer is connected to the pendulum masses by a clip connection.

6. The centrifugal pendulum device according to claim 4, wherein the centrifugal pendulum comprises an additional mass arranged between the pendulum masses and the spacer is arranged between the additional mass and the pendulum masses.

7. The centrifugal pendulum device according to claim 4, wherein the spacer is L-shaped and has an axially extending stop lug.

8. The centrifugal pendulum device according to claim 7, wherein the stop lug engages around the pendulum masses on the radial inner side.

9. The centrifugal pendulum device according to claim 7, wherein a rubber coating is arranged on the stop lug.

10. The centrifugal pendulum device according to claim 4, wherein the spacer is arranged on both pendulum masses.

11. A centrifugal pendulum device for a drive train of a motor vehicle, the centrifugal pendulum device comprising:
a carrier disc;
at least one centrifugal pendulum arranged on the carrier disc and configured to move relative to the carrier disc along a predetermined pendulum path, wherein the centrifugal pendulum comprises first and second pendulum masses arranged on opposite sides of the carrier disc;
at least one radial stop surface arranged on the carrier disc; and
at least one spacer arranged on a side of the first or the second pendulum mass facing the carrier disc, wherein the spacer includes an axially extending stop lug engaged with a radial inner side of the respective first or second pendulum mass.

12. The centrifugal pendulum device according to claim 11, wherein the spacer is L-shaped.

13. The centrifugal pendulum device according to claim 11, wherein a rubber coating is arranged on the stop lug.

14. The centrifugal pendulum device according to claim 11, wherein the spacer is connected to the first or the second pendulum mass by a clip connection.
